(19) United States
(12) Patent Application Publication
(10) Pub. No.: US 2014/0311309 A1
(43) Pub. Date: Oct. 23, 2014

(54) CUTTING ASSEMBLY

(71) Applicants: DAVID PYNT, SCARBOROUGH (AU); MICHAEL JOHN LAYBOURNE HORT, CHATSWOOD (AU); JOHN MCBRIEN LEVEY, BONDI BEACH (AU)

(72) Inventors: DAVID PYNT, SCARBOROUGH (AU); MICHAEL JOHN LAYBOURNE HORT, CHATSWOOD (AU); JOHN MCBRIEN LEVEY, BONDI BEACH (AU)

(21) Appl. No.: 14/208,165

(22) Filed: Mar. 13, 2014

Related U.S. Application Data
(62) Division of application No. 12/666,647, filed on Jul. 7, 2010.

(30) Foreign Application Priority Data
Jul. 3, 2007 (AU) 2007903613

(51) Int. Cl. B26D 1/10; B26D 7/01; B26D 7/14; B26D 7/00

(52) U.S. Cl. CPC B26D 1/105; B26D 7/0006; B26D 7/015; B26D 7/14
USPC 83/56; 83/614; 83/175

(57) ABSTRACT

In one preferred form there is provided a cutting assembly (10) for use in a kitchen. The cutting assembly includes a housing (12) adapted to house a roll of sheet material such as plastic wrap. There is provided a cutting surface (24) having a slit (28); and a slideable cutting arm (22) having a cutting edge (27) adapted for receipt in the slit (28) when moved along the slit (28) to cut the sheet material. The cutting surface (24) includes a high friction gripping surface (74) having a gloss finish for gripping the sheet material on the cutting surface.

### INCORPORATION BY REFERENCE

This application is a divisional application of U.S. patent application Ser. No. 12/666,647. Priority is claimed from Australian provisional application 2007903613 filed 3 Jul. 2007. The disclosure of these documents is hereby incorporated by reference.

### TECHNICAL FIELD

This invention relates to a cutting assembly and in particular to a cutting assembly for cutting sheet materials.

The invention has been developed primarily for use with sheet materials found in a typical kitchen. Sheet materials include products sold as GLAD WRAP (Trade Mark), GLAD BAKE (Trade Mark), GLAD GO-BETWEEN (Trade Mark), plastic wrap, cling film, cling wrap, food wrap, plastic bags, baking paper, greaseproof paper and aluminium foil. The invention will be described hereinafter with reference to this application. However, it will be appreciated that the invention is not limited to this particular field of use.

### BACKGROUND ART

Sheet materials such as plastic wrap, aluminium foil, and baking paper have been found to be extremely useful additions to a well equipped kitchen. Plastic wrap is a convenient means to cover foods stuffs, for storage in a fridge for example, or for cooking in a microwave. Aluminium foil is used every day in oven cooking to prevent excess browning for example, and also for cooking on a fire, or barbecue. Baking paper can be used, amongst other things, to line cake or loaf tins, and for cooking food “en papillote”.

Plastic wrap, aluminium foil and baking paper are conveniently sold and stored as a roll of material, around a tubular core. Conventionally the roll of material is provided in a box which incorporates a means for cutting a length of material away from the roll. When a person wants a piece of plastic wrap, for example, an end of the sheet of plastic wrap is pulled from the roll, out of the box through a suitable gap, and over a serrated or other cutting edge that runs along one side. The serrated or cutting edge cuts through the sheet material that overlays it and breaks a piece away from the roll, so that the plastic wrap can be used elsewhere.

There are serious problems with the aforementioned known means of cutting sheet materials. These problems include difficulties in cutting a neat piece of sheet material, finding the end of the roll, and cutting a piece of material when the roll has become tangled or several parts overlaid one on another.

One most serious problem is that the serrated or other cutting edge lies on the outside of the box, and is unguarded. Hence, it is easy to inadvertently pick up the box by the serrated or cutting edge and cut your hand. Or a person may accidentally run their hand or arm over the serrated or other cutting edge and injure themself. Clearly this is dangerous and undesirable.

An attempt has been made to try to overcome the problem by providing a cutting system for plastic wrap, that has the cutting edge guarded against accidental contact. The known system has a plastic channel, attached along the length of a box containing a roll of plastic wrap, and a cutting tool that can move along the channel from one end of the box to the other. The cutting tool includes a blade and a handle so that a person can hold the handle and move the blade through the sheet of plastic wrap, overlaying the channel, to cut a piece away. The known system also includes a sticky coating on the channel which somewhat attracts the plastic wrap to the channel.

The known system described above is a far safer and much improved system to the serrated or cutting edge system, but does have significant disadvantages. The known system is intended to only cut plastic wrap, and does not work on other frequently used sheet materials, such as aluminium foil and baking paper. Also the known system does not cut the plastic wrap at all well unless the sheet of plastic wrap is straight and slightly under tension over the cutting strip. The sticky coating assists here to hold onto the plastic wrap to make it easier to cut. Unfortunately, the sticky coating does not work if wet or if it gets dirty. In a kitchen, and in particular in a commercial kitchen, with many people trying to use the roll of plastic wrap the known system quickly becomes difficult to use or unusable; this can be extremely frustrating. Commercial kitchens are high stress environments where time is money. There is no room in the schedule for time to straighten out a roll of plastic wrap, return it to its box, clean the sticky strip, and perhaps disentangle the blade from ragged ends of plastic wrap that have not cut properly. The product must be ready to use, quickly and efficiently.

It is an object of the present invention to provide an improved cutting assembly for cutting sheet material that, at least to some extent, ameliorates some of the problems of the prior art.

### SUMMARY OF THE INVENTION

According to a first aspect of preferred embodiments herein described there is provided a cutting assembly for use in a kitchen, the cutting assembly including: a housing adapted to house a roll of sheet material such as plastic wrap, a cutting surface having a slit; and a slideable cutting arm having a cutting edge adapted for receipt in the slit when moved along the slit to cut the sheet material; wherein the cutting surface includes a high friction gripping surface having a gloss finish for gripping the sheet material on the cutting surface.

Preferably the surface is provided by a thermoplastic polyester elastomer.

Preferably the surface is provided by an elastomer coating over a rigid polymer substrate.

Preferably the cutting arm is hinged to allow slight up and down movement.

Preferably the cutting arm is moveable up and down above the cutting surface to enable the cutting arm to be moved up and over an edge of the sheet material into a desired position to commence cutting.

Preferably the cutting edge is provided by a cutting tool that is removably installed on the cutting arm.

Preferably the cutting assembly includes a guide means for constraining the cutting arm to run parallel to the slit, the guide means being located behind the cutting arm, with an aperture being located between the guide means and the cutting surface, the sheet material being adapted to be fed through the aperture onto the cutting surface to overlie the slit.

Preferably the guide means comprises a rod and the cutting arm is mounted on the rod.

Preferably the housing is adapted to receive rolls of different dimensions.

Preferably the cutting surface includes a second portion so as to provide corresponding first and second surfaces having the slit therebetween, one of the surfaces being at an angle compared to the other.

Preferably the slit is adapted to bisect the angle between second surface of the cutting surface and the first surface of the cutting surface.

Preferably the angle of the second surface of the cutting surface is at substantially 35 degrees to the first surface.

Preferably the leading edge of the cutting surface is configured to increase tension in the sheet material when a leading edge of the sheet material is pulled away from the roll of sheet material and over the cutting surface.

Preferably a base of the housing is configured to receive one or more spindle means, each spindle means having a slightly smaller diameter than a core of the roll of sheet material so as to enable receipt of the spindle means within the core.

Preferably spacer means are provided to hold ends of each spindle means in chosen positions in the housing.

Preferably the ends of the spindle means project beyond the roll of sheet material to seat in seating means in the housing.

Preferably the seating means is adapted to receive more than one roll of sheet material.

Preferably the cutting surface is removable from the housing for cleaning or replacement.

Preferably the cutting edge is configured to be received in the slit without contacting the cutting surface.

According to a second aspect of preferred embodiments herein described there is provided a kitchen method for cutting sheet material comprising cling wrap typically found in a kitchen, comprising: i) drawing a lead edge of the sheet material from a roll over a cutting surface comprising a a high friction gripping surface having a gloss finish for gripping the sheet material on the cutting surface; and ii) sliding a cutting means along the slit through the sheet material so as to divide a piece of the sheet material from the roll.

The sheet material may be any suitable material including paper, metal, fabric, plastic or rubber. This includes plastic wrap, aluminium foil or baking paper. In an advantageously preferred form of the invention the sheet material comprises plastic wrap.

A preferred cutting assembly for cutting sheet material includes a cutting surface having first and second surfaces having a slit there between, one of the surfaces being at an angle compared to the other, and a slideable cutting means, the cutting means having a cutting edge adapted for receipt in the slit when the cutting means is moved along the slit. In the embodiment the cutting assembly includes a guide means to constrain the cutting means to run parallel to the slit. The guide means is located behind the cutting means, and an aperture is located between the guide means and the cutting surface through which a sheet material is adapted to be fed.

Preferably, the cutting assembly is adapted to be able to cut more than one kind of sheet material. In a preferred form of the invention, many kinds of sheet material can be cut by the cutting assembly. In a preferred form of the invention the cutting assembly is adapted to be able to cut at least three kinds of sheet material. The at least three kinds of sheet material may be plastic wrap, baking paper and aluminium foil.

Preferably the cutting assembly includes a housing, which may take any suitable form. Preferably, the housing is a substantially cuboid shape with substantially square first and second ends and substantially rectangular top, bottom and first and second sides. The housing may be made of any suitable material such as plastic, wood, or metal or any combination of suitable materials. Preferably, the housing is made of moulded plastic. The housing may include decorative elements. The housing may include trade marks, brands details, colours, advertising, safety instructions or other information relating to the sheet material contained therein.

The housing preferably has a base, and a top. The base and top may divide the housing substantially in half longitudinally. The base may take any suitable form. The base may be rectangular in cross-section. Preferably, the base has a pair of ends, spaced apart and joined to a pair of longitudinal sides around a bottom, and having an open top. The base may include one or more cut-outs. Preferably, a cutout is included in each end of the base, to facilitate lifting or moving of the cutting assembly. There may be a second cut-out in one or more of the sides of the base. The first and/or second cut-outs may be moulded indents or recesses, in the base of the housing. In this form of the invention, the moulded indents or recesses may form handles or hand-holds for moving and lifting the cutting assembly. The bottom of the base of the housing may include one or more moulded indents or recesses.

In an embodiment, the housing may not be divided into a base and top. In this form, there may be cut-outs or recesses formed in any part of the housing to provide handles or hand-holds to facilitate lifting and/or moving of the cutting assembly.

Preferably, the base of the housing is configured to receive a spindle means. The spindle means may be made of any suitable material including metal or plastic. Preferably, the spindle means is made of plastic. Preferably, the spindle means is a cylindrical rod made of extruded polymer. The spindle means may be configured to closely correspond to a tubular core of a roll of sheet material. The spindle means may have a slightly smaller diameter than the core of the roll of sheet material wherein the spindle means can readily be passed there through.

In one form of the invention more than one spindle means may be housed within the housing to enable a plurality of sheet materials to be dispensed from the same cutting assembly. In another form of the invention, spacer means may be provided to hold the ends of the spindle in different positions. The spacer means may enable spindles of different core diameters to be installed in the housing. In yet another alternative form of the invention more than one spindle means is provided, each being adapted for receipt in the core of a different roll of sheet material, each roll having different dimensions. The different dimensions may be length and/or diameter of the core.

The spindle can take the form of two individual plugs adapted to be ‘push fit’ inserted into each end of the core. Preferably, the core of the roll of sheet material is made of cardboard.

Preferably the spindle means is slightly longer than the roll of sheet materials, wherein a first end and a second end of the spindle means project beyond the end of the roll of sheet material. Preferably, the first and second ends of the tubular core of the spindle means are seated in seating means in the housing. Preferably, the seating means are in the base of the housing. Each of the seating means may include a recess adapted to receive the ends of the spindle means. The recess may take any suitable shape. Preferably, the recess is substantially U-shaped.

Preferably, in use, the spindle means is passed through the tubular core of the roll of sheet material wherein the protruding ends of the spindle means are positioned in the substantially U-shaped recesses in the seating means. The seating means may be adapted to receive more than one roll of sheet material, having different dimensions. The different dimensions may be a different length and/or diameter.

There may be one or more seating means. Preferably, there are at least one pair of seating means. Preferably, there are two pairs of seating means adapted to receive two rolls of sheet material of the rolls having different dimensions. The rolls of sheet material may have a different length or different core width. The two pairs of seating means may be spaced apart within the housing at different spacings in order to receive spindle means and different rolls of different lengths. The recesses of the two pairs of seating means may be of different sizes and/or shapes to be adapted to receive spindle means and hence rolls of sheet material with different dimensions.

The seating means may be integral to the housing or mounted thereon. Preferably, the seating means are formed of moulded plastic. The seating means may, in an alternative form of the invention, be provided in any other part of the housing.

Preferably, the top of the housing is hinged to the base. Alternatively, the top may rest on the base. The top and base may clip or otherwise be temporarily fastened closed. The top may, in another form of the invention be removably attached to the base. When the top is opened the roll of sheet material and the spindle means may be positioned in the base of the housing or removed therefrom. Preferably, a leading edge of the sheet material protrudes through an aperture in the top of the housing. Preferably, the top includes a lid means movable between a closed and an open position. In the closed position the lid means may lie substantially flush with the remainder of the top of the housing. The lid means may be clipped or otherwise temporarily fastened closed. In the open position the lid means may enable access to the slideable cutting means. The lid means is preferably hingeably attached to the top of the housing. The lid means may form part of the top of the housing or be a separate piece. Preferably, the lid means is made of a suitable plastic material.

In the closed position the leading edge of the sheet material may protrude between the lid means and the top of the housing. Preferably, the lid means includes a recess or edge. The recess, to at least some extent, may help to maintain the sheet material in position on the cutting surface. The recess may be made of any suitable material and may take any suitable form. Preferably, the recess has a substantially flat surface that contacts the sheet material when the lid means is in the closed position. Preferably, the recess has rounded edges. The recess may take any suitable shape. Preferably, the recess is a substantially rectangular cuboid shape and generally corresponds to the length of the sheet material. The recess may also allow visual access to the sheet material. The recess may be made of a transparent plastic. When the lid means is in the open position, access is provided to the slideable cutting means.

In an alternative form of the invention the lid means may form the top of the housing and be attached directly to the base means. In this form of the invention the roll of sheet material may be positioned within the housing through the lid means, bottom of the housing or any other suitable means.

Preferably the first and second surfaces of the cutting surface are configured, to at least some extent, facilitate cutting of the sheet material. Preferably, the first and second surfaces of the cutting surface substantially increase the friction of the sheet material moving over the cutting surface. The cutting surface may grip, to at least some extent, the sheet material. The cutting surface may be include a suitable material to increase friction of the sheet material over the surface. Preferably, the cutting surface includes a rubber or elastomeric material. More preferably, the cutting surface is made from a rigid polymer forming the base and an elastomer forming the surface. The rigid polymer and elastomer are preferred to be manufactured by co-moulding or co-extruding. Preferably, the cutting surface is removable from the housing. The cutting surface may be removed for cleaning or replacement.

The angle of the second surface of the cutting surface may be any suitable angle different from the first surface. Preferably, the angle of the second surface of the cutting surface is substantially 35 degrees different from the first surface.

Preferably, the angle between the first and second surfaces facilitates the retention of the sheet material on the cutting surface. The configuration of the cutting surface may increase the tension in the sheet material when the leading edge of the sheet material is pulled away from the roll of sheet material and over the cutting surface.

Preferably, the angle of the second surface of the cutting surface is substantially 35 degrees different to that of the first surface and the cutting surface includes an elastomeric outer surface, wherein as the leading edge of the sheet material is pulled from the roll of sheet material over the cutting surface the cutting surface grips, to at least some extent, the sheet material and increases the tension of the sheet material to facilitate the cutting thereof.

Preferably the slit runs substantially the length of the cutting surface. The slit may run only a proportion of the length of the cutting surface. The slit may be at any suitable angle relative to the first surface including substantially vertical. Preferably the slit bisects the angle of difference between second surface of the cutting surface and the first surface of the cutting surface. The angle of the slit may be substantially 17.5 degrees. The slit may have any suitable width. Preferably, the slit is 1.5 mm in width.

The slideable cutting means may take any suitable form. Preferably, the slideable cutting means is adapted to slide only in the direction defined by the slit. The slideable cutting means may engage with means to guide it along the slit. Preferably the slideable cutting means has an arm means. Preferably, the slideable cutting means is mounted in a fashion so as to allow it to move parallel to the slit, and to slide freely along the entire length of the cutting surface. The cutting means may be constrained by the arm means being mounted on the guide means. The guide means may be a rod means or other linear constraint such as a groove or track. The arm means may include an aperture through which the rod means is passed, or may include a section adapted to mate with the guide means. In a preferred form of the invention the guide means being in the form of the rod means is attached across the lid means so that the slideable cutting means can easily slide along the rod means from one side and back again with minimum force, and without becoming caught. In an alternative form of the invention, the guide means may be installed in the base or top of the housing. For instance, the rod means may provide the pivot for the lid means. Preferably, the rod means is made of metal or other suitable material with a low coefficient of friction. Preferably, the slideable cutting means is moveable, to some extent, up and down above the cutting surface to enable the slideable cutting means to be moved up and over an edge of the sheet material into a desired position to commence cutting. Preferably the movement of the slideable cutting means is restricted to prevent user injury from the cutting edge.

Preferably, the slideable cutting means is configured to have a cutting face substantially corresponding to the configuration of the first and second surfaces of the cutting surface. Preferably, the cutting face has a first face and a second face, the first face corresponding to the first cutting surface and the second face corresponding to the second cutting surface. Preferably, the first cutting surface and the first cutting face are at one angle and the second cutting surface and the second cutting face are at an angle 35 degrees different. Preferably the surfaces of the slideable cutting means are parallel to but offset from the adjacent faces of the cutting surfaces. Preferably, the faces of the slideable cutting means are shaped to allow the slideable cutting means to slide easily over the edge of the sheet material, and to slide easily over the surface of the sheet material. The edges of the slideable cutting means may have a chamfer and a radius. The face of the slideable cutting means which comes into contact with the sheet material to be cut may be of a convex form, to minimise contact with the sheet material. Preferably, the slideable cutting means acts at least to some extent to hold the sheet material in tension by stretching it across the slit when the sheet material is gripped between the slideable cutting means and the cutting surface, so as to promote a clean cut in the sheet material.

The slideable cutting means may be made of any suitable material or combination of materials such as metal or plastic. The slideable cutting means is preferably made of a suitable slippery material. The slideable cutting means may be made as a single piece or several pieces assembled together. Preferably, the surface of the slideable cutting surface has a lower coefficient of friction compared to the sheet material.

Preferably, downward pressure on the slideable cutting means creates tension in the sheet material.

Preferably, the slideable cutting means is adapted to be readily moved from side to side by the user holding the cutting means and moving from one side of the housing to the other. Preferably, the cutting edge is removably installed in the slideable cutting means. The cutting edge may be removed by means of a screw or other suitable fixing means. The cutting edge may take any suitable form to cut through the sheet material as the slideable cutting means moves along the rod means. Preferably the cutting edge is configured to be received in the slit without contacting the cutting surface. Preferably the cutting edge includes a metal blade. The blade is preferably a bidirectional blade. More preferably the slideable cutting means is disposed at an angle to the sheet material. Most preferably the angle is 25 degrees. The sharpened portion of the blade may be substantially an isosceles triangle shape. The blade preferably has chamfered edges. The blade may be provided with a cover which can be used to protect the blade when it is not installed in the slideable cutting means.

One or more guide means may be included to guide the sheet material leaving the roll of sheet material over the cutting surface. The guide means may lightly hold the sheet material to prevent movement away from the cutting surface. The guide means may include two substantially rectangular projections, positioned apart from one another, projecting towards the leading edge of the sheet of material. The guide means may grip the sheet material, to at least some extent. Preferably, the guide means exerts pressure on one surface of the sheet material, such that the sheet materials is held between the guide means and the cutting surface. The pressure exerted by the guide means may press the sheet material onto the cutting surface, which has a higher amount of grip than the surface of the guide means.

A thermoplastic polyester elastomer (TPE) may be used to form the cutting surface. TPE has an affinity for cling wrap type materials. One the other hand, the rubbery nature of the TPE may be used as the grip for materials such as an aluminium foil and baking paper. As such, a portion of cutting surface may have a gloss finish for gripping the cling wrap type materials whereas the cutting surface and a band of the cutting surface may have a matt or rubbery finish for gripping the aluminium foil, baking paper or the like. This combination may provide material softness and a fine surface texture thereby enhancing the friction between the cutting surface and the sheet material. It is preferred that the cutting surface is manufactured by co-moulding or co-extruding having the rubber or elastomeric material forming an upper surface and a stiff polymer forming the base. In one form of the invention the cutting assembly includes attachment means for removably mounting on a wall. In an alternate form of the invention the cutting assembly includes means for removably attaching to a flat surface.

There may be provided a method for cutting sheet material including the steps of: 1) drawing a lead edge of a sheet material from a roll over a first cutting surface and a second cutting surface having a slit there between, one of the first and second surfaces being at a different angle relative to the other; and 2) sliding a cutting means along the slit through the sheet material so as to divide a piece of the sheet material away from the roll.

The method may include the additional steps of: 3) threading a roll of sheet material onto a spindle means; and 4) mounting the spindle and roll in seating means within a housing.

### BRIEF DESCRIPTION OF THE DRAWINGS

The invention will now be described in connection with a non-limiting preferred embodiment with reference to the accompanying drawings, in which:

FIG. 1 is a perspective view of the cutting assembly according to the present invention, with the lid open;

FIG. 2 is a view from above of the cutting assembly of FIG. 1;

FIG. 3 is a front view of the cutting assembly of FIG. 1;

FIG. 4 is a side view of the cutting assembly of FIG. 1;

FIG. 5 is a view from behind of the cutting assembly of FIG. 1;

FIG. 6 is a view from below of the cutting assembly of FIG. 1;

FIG. 7 is a detailed view of one end of the cutting assembly as illustrated in FIG. 6;

FIG. 8 is a detailed view of one end of the cutting assembly as illustrated in FIG. 1, showing detail of the cutting arm;

FIG. 9 is a detailed view of the other end of the cutting assembly as illustrated in FIG. 1;

FIG. 10 is a perspective view of the cutting assembly of FIG. 1, with the lid closed;

FIG. 11 is a view from above of the cutting assembly of FIG. 10;

FIG. 12 is a view from the front of the cutting assembly of FIG. 10;

FIG. 13 is a view from one end the cutting assembly of FIG. 10;

FIG. 14 is a view from behind of the cutting assembly of FIG. 10;

FIG. 15 is detailed perspective view of the cutting tool and cutting surface of FIG. 4;

FIG. 16 is a perspective view of the cutting tool of FIG. 15; and

FIG. 17 is a perspective view of the base of the housing of FIG. 1 with the top removed;

FIG. 18 is a perspective view of a cutting surface of the cutting assembly of FIG. 1; and

FIG. 19 is an end view of the cutting surface of FIG. 18.

### DETAILED DESCRIPTION OF THE INVENTION

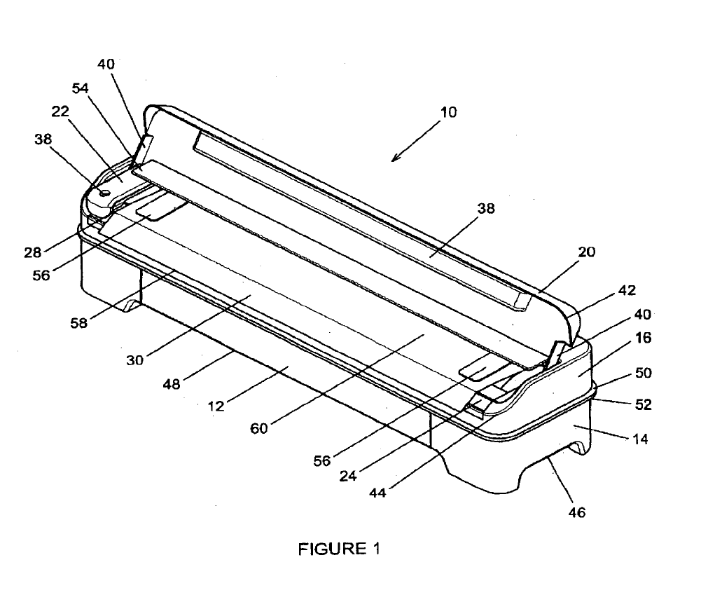

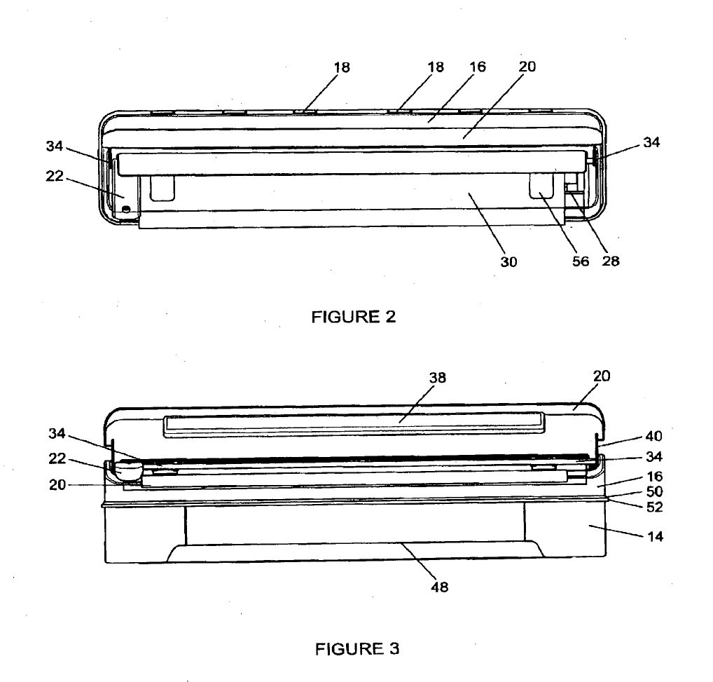

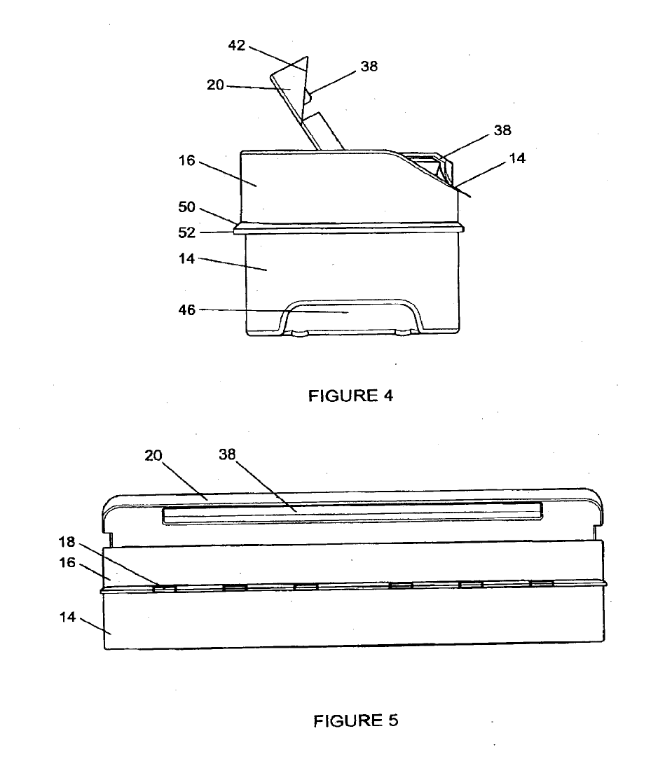

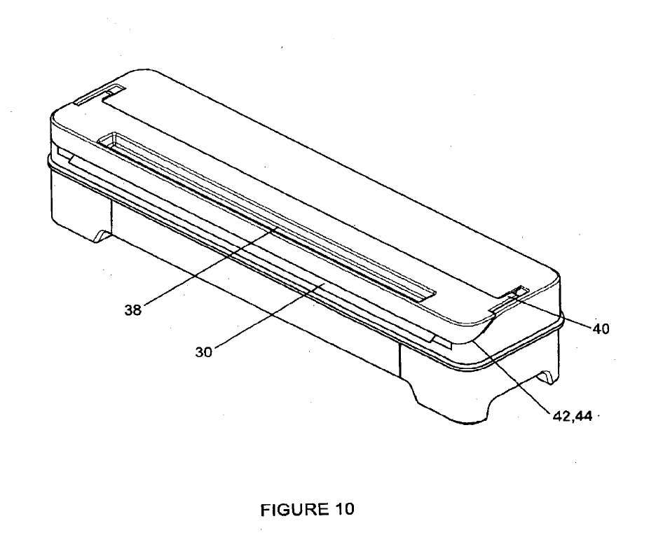

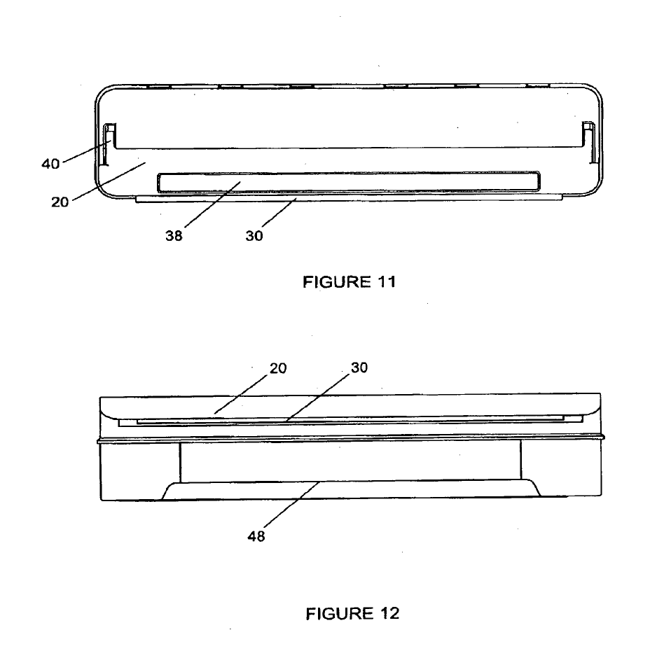

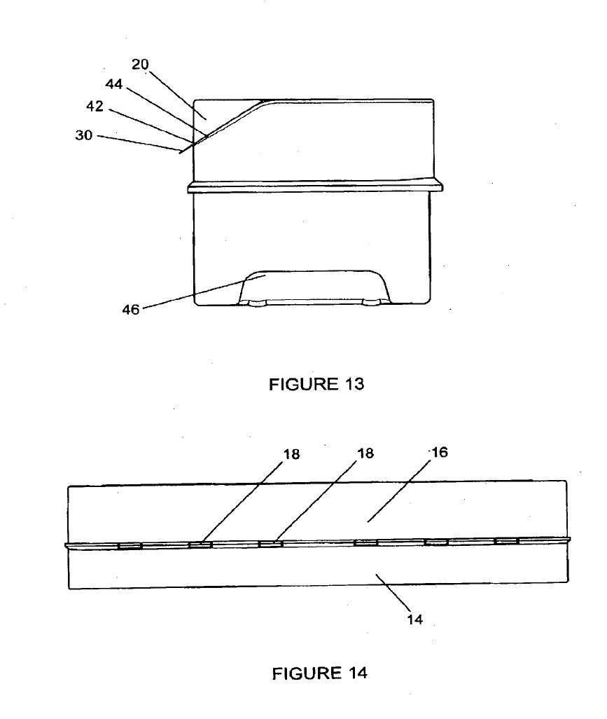

Referring first to FIGS. 1 to 5 and 10 to 14, cutting assembly 10 is shown, including housing 12 having base 14 and top 16. FIGS. 1 to 5 illustrate the cutting assembly in an open state and FIGS. 10 to 14 illustrate the embodiment in a closed state. In the illustrated embodiment base 14 is hinged to top 16 by hinges 18 (refer FIG. 5). Top 16 may be clipped to base 14 in any suitable manner. Lid 20 lies in top 16, lid 20 may include a clipping means to keep lid 20 shut when not in use.

Housing 12 as illustrated is made of a suitable plastic but alternative materials could be used including wood or metal or a combination of suitable materials.

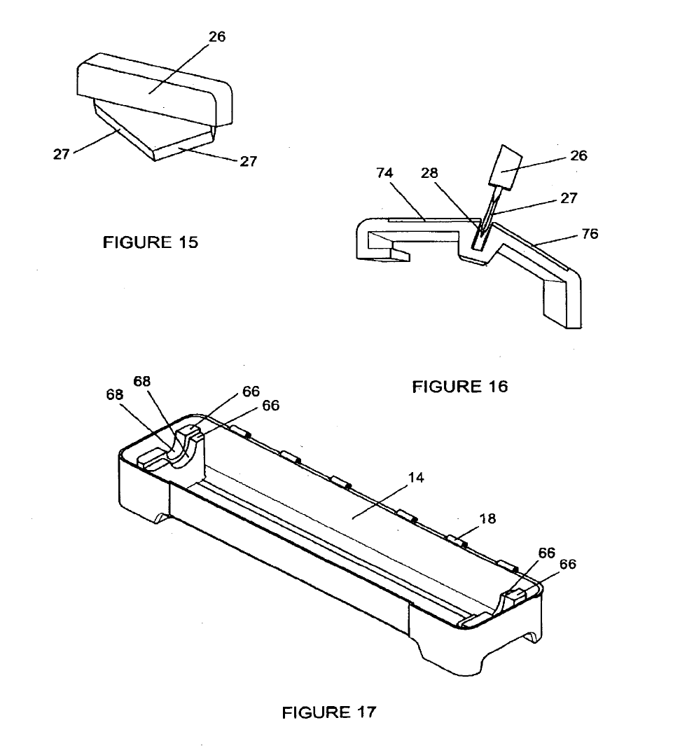

Cutting arm 22 is shown in a first position on cutting surface 24 with cutting tool 26 and cutting edges 27 (refer FIGS. 15 and 16) lying in slit 28. Cutting edges 27 as shown are chamfered to provide a sharp edge. In this embodiment, the cutting edges 37 are in the form of blades disposed at 25 degrees to the sheet 30. This angle has been selected carefully, as if the angle is too small, the blade is likely to skate over the top of the material whereas if the angle is too large, the blade is prone to bunching up the sheet material 30. Overlying slit 28 is sheet 30 of roll of sheet material 32 (not shown), having a leading edge 34. Sheet 30 of roll 32 as described may be plastic wrap baking paper or aluminium foil. The illustrated embodiment cuts each of the aforementioned sheet materials equally well. The invention is also applicable to other sheet materials desirable to cut such as plastic sheeting, GLAD GO-BETWEEN (trade mark), rubber or plastic sheeting, tissue paper, writing paper or any other sheet material. In an alternative form of the invention, sheet 30 may not be provided on roll 32 but by another suitable means.

Housing 12 in the illustrated embodiment is configured to be of suitable dimensions to receive roll 32 of sheet material. Housing 12 is adapted to receive different rolls 32 of different dimensions for example, a roll of baking paper may be housed initially only to be replaced with a roll of plastic wrap. It is envisaged that housing 12 could be adapted to be suitable for receipt of roll 32 of any dimensions.

Cutting arm 22 is mounted on rod 34 through aperture 36 (not shown), rod 34 being mounted across lid 20. Cutting arm 22 can slide readily from one side of housing 12 to the other side by passing along rod 34.

Lid 20 in the illustrated embodiment has recess 38 which may help to hold sheet 30 in position when in the closed state or during transit for example. As illustrated recess 38 is made of transparent plastic (refer FIG. 10) through which sheet 30 can be seen when lid 20 is in a closed position. In other forms of the invention recess 38 could be made of opaque material or any suitable material. The recess 38 may be omitted entirely.

Lid 20 is hinged to top 16 by rod 34 in the illustrated embodiment but any suitable hinging means may be used. Edge 42 of lid 20 is configured to correspond to edge 44 of top 16 so that in the closed position lid 20 lies flush to the rest of housing 12. Housing 12 of the illustrated embodiment has been developed with ergonomics and ease of use in mind. For example, first recesses 46 at either end of base 14 and second recess 48 enable a person to readily pick up cutting assembly 10. First recesses 46 and second recess 48 may take any suitable form or may be omitted entirely if preferred. Lip 50 of top 16 and lip 52 of base 14 are configured to correspond one to the other as top 16 is closed on base 14.

Guide 54 has fingers 56 which lie on sheet 30 to bias it onto cutting surface 24, and to keep sheet 30 in position for cutting. Guide 54 as illustrated is attached across the length of housing 12 and is made of a suitable plastic material. Fingers 56 to some extent grip the sheet material.

In use, roll 32 is positioned within base 14, top 16 is closed and lid 20 is raised. Leading edge 58 of sheet 30 is then drawn out of opening 60, over cutting surface 24 and slit 28 so that a short length of sheet 30 extends out of cutting assembly 10. Cutting arm 22, is moved along rod 34 moving cutting tool 26 and cutting edges 27 (refer FIGS. 15 and 16) along slit 28 and through sheet 30 whereby a piece of sheet 30 is cut so it can be taken away from roll 32 (not shown), for use.

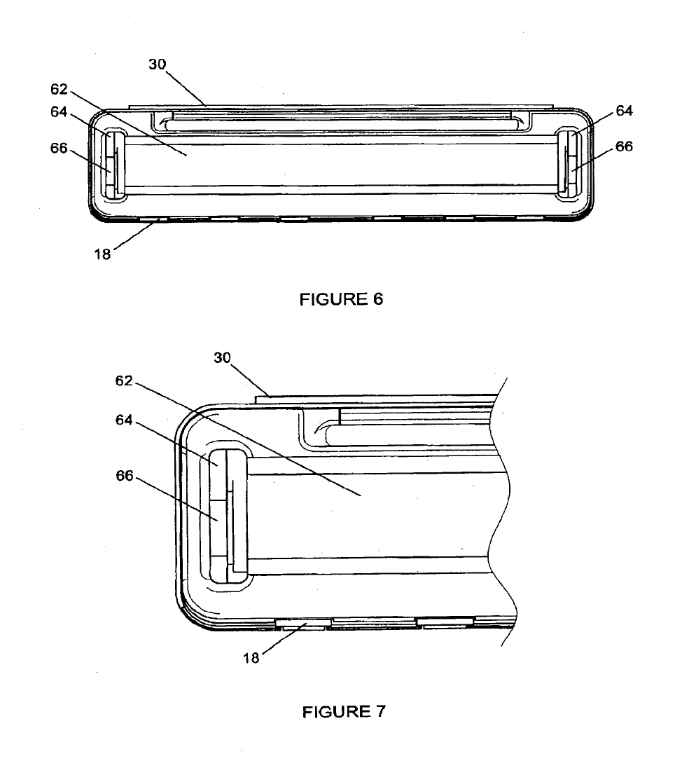

Referring to FIGS. 6, 7 and 17, underside 62 of base 14 can be seen, having two recesses 64. Roll 32 (not shown) is installed in base 14 by having a spindle (not shown) being passed through the tubular core of roll 32 so that the ends of the spindle protrude slightly from roll 32. Seats 66 are adapted to receive the ends of the spindle. As can be seen in FIG. 17 in particular, two pairs of seats 66 are included to enable more than one roll 32 of different dimensions, such as length or diameter to fit in base 14, for use. Seats 66 may take any suitable form but as illustrated include a substantially semi-hemispherical cavity 68.

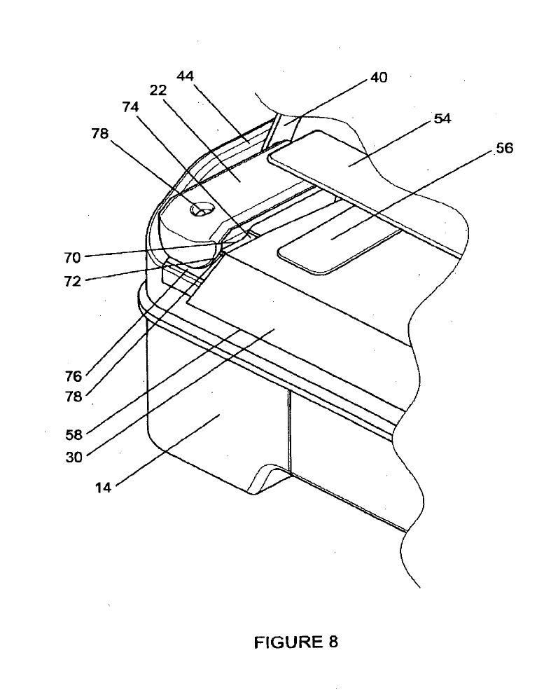

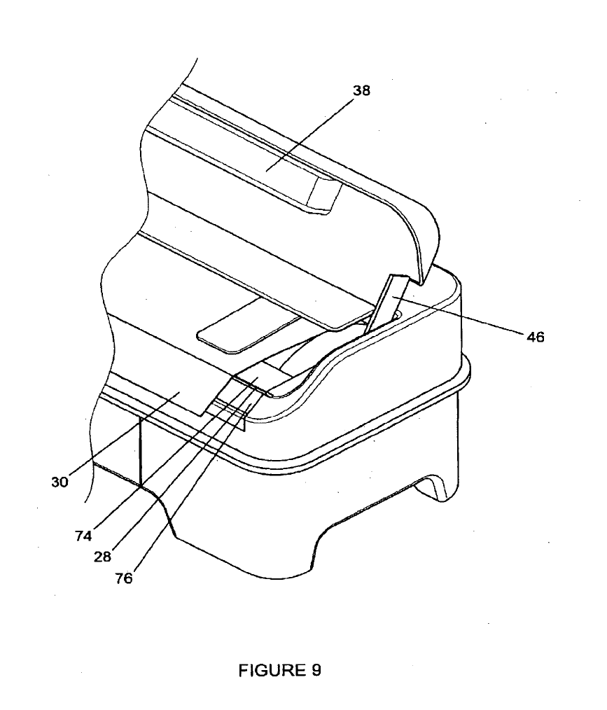

Referring to FIG. 8 the detail of cutting arm 22 is shown having a pair effaces 70 and 72 corresponding to cutting surface 24. Cutting surface 24 has first surface 74 and second surface 76 with slit 28 lying between them. As illustrated first surface 74 and corresponding face 70 of cutting arm 22. Second surface 76 is 35 degrees different from the angle of first surface 74, and face 72 corresponds to the angle of second surface 76. As cutting faces 70 and 72 correspond to cutting surfaces 74 and 76, cutting arm 22 can move smoothly over sheet material 30 and maintains sheet 30, to some extent, between cutting surface 24 and cutting faces 70 and 72 as it moves. Cutting surfaces 74 and 76 in the illustrated embodiment have an elastomeric coating over a rigid polymer substrate and cutting arm 22 is also made of a rigid polymer with a smooth friction resistant coating. In use sheet material 30 is held with a slight downward pressure onto the cutting surface 24 and cutting arm 22 can move very smoothly over sheet 30 and tension is created in sheet 30. Cutting arm 22 is hinged (not shown) to allow slight up and down movement but not so far that cutting tool 26 could be exposed and cause injury.

Referring to FIGS. 15 and 16, slit 28 can be seen to lie at an angle between the angles of first and second surfaces 74 and 76 of cutting surface 24. In the illustrated example the angle between the first and second surfaces 74 and 76 is 35 degrees and so slit 28 is at an angle of 17.5 degrees. Cutting tool 26 is positioned in cutting arm 22 to run along slit 28 without cutting tool 26 and cutting edges 27 touching the sides of slit 28. Cutting tool 26 and cutting edges 27 create a bidirectional cutting edge. Cutting tool 26 is removably installed by means of screw 78 (refer FIG. 1 also).

Any suitable angle of second surface 76 can be used. An angle of 35 degrees difference has been found to be particularly beneficial in assisting holding sheet 30 onto cutting surface 24. Also tension in sheet 30 is increased as leading edge 58 is drawn over cutting surface 24 and trails over the edge, as sheet 30 is held somewhat on first surface 74 due to the high friction, gripping coating. The increased tension in sheet 30 makes it easier for cutting tool 26 and cutting edges 27 to cut through sheet 30, makes the cut straighter and significantly reduces the risk of sheet 30 rucking and becoming tangled.

In various embodiments the seating means is adapted to receive more than one roll of sheet material. The housing may include two pairs of seating means spaced apart within the housing in order to receive two spindle means and rolls of sheet material of different lengths. The slit may run part way of the length of the cutting surface.

The invention has industrial applicability in that it provides a cutting assembly which can give the benefits of cutting most if not all commonly used sheet materials including aluminium foil and baking paper in a ready to use, quick and efficient fashion.

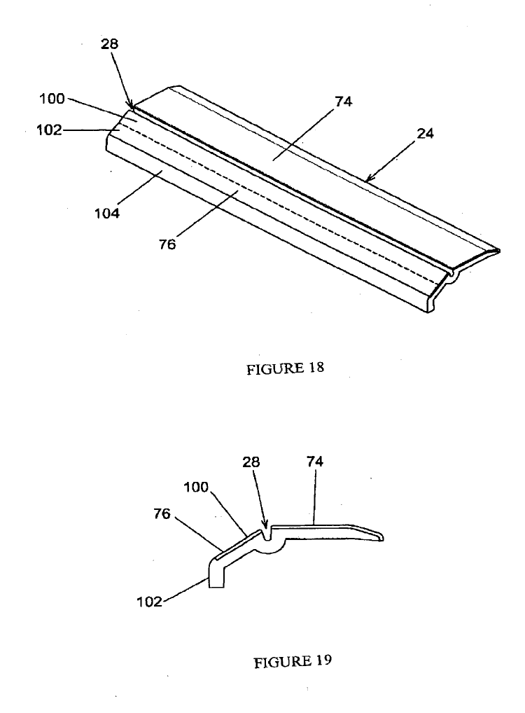

Referring to FIGS. 18 and 19, the material and texture of the cutting surface 24 play an important role in the performance of the cutting assembly in this preferred embodiment. In this embodiment, a thermoplastic polyester elastomer (TPE) is used which has an affinity for cling wrap type materials. This affinity is found to be the greatest when the surface finish of the TPE is gloss. On the other hand, the rubbery nature of the TPE is used as the grip for materials such as an aluminium foil and baking paper. As such, in the present embodiment, a portion 100 of cutting surface 76 has a gloss finish for gripping the cling wrap type materials whereas the cutting surface 74 and band 102 of the cutting surface 76 have a matt or rubbery finish for gripping the aluminium foil, baking paper or the like. This combination provides material softness and a fine surface texture thereby enhancing the friction between the cutting surface 24 and the sheet material 30. It should also be noted that the cutting surface 24 is manufactured by co-moulding or co-extruding having the rubber or elastomeric material forming an upper surface and the rigid polymer forming the base 104.

In one embodiment there is provided a cutting assembly for cutting a sheet material, including, a cutting surface including first and second surfaces having a slit there between, one of the surfaces being at an angle compared to the other, and a slideable cutting means, the cutting means having a cutting edge adapted for receipt in the slit when the cutting means is moved along the slit. A guide means for constraining the cutting means to run parallel to the slit, the guide means being located behind the cutting means, and an aperture which is located between the guide means and the cutting surface through which a sheet material is adapted to be fed. The cutting assembly is adapted to be mounted on or in a housing adapted for receipt of a roll of sheet material. The sheet material may be chosen from the group of paper, metal, fabric, plastic, rubber, plastic wrap, aluminium foil and baking paper.

The housing has a base and a top dividing the housing into two halves longitudinally. The housing is configured to receive one or more spindle means. Each spindle means has a slightly smaller diameter than a core of the roll of sheet material so as to enable receipt of the spindle means within the core. Spacer means are provided to hold ends of each spindle means in chosen positions in the housing. The ends of the spindle means project beyond the roll of sheet material to seat in seating means in the housing. A first cut-out is included in each of a pair of ends of the base, to facilitate lifting or moving of the cutting assembly. A second cut-out is included in one or more of a pair of longitudinal sides around the base, the sides being joined to the pair of ends of the base. The base of the housing includes one or more moulded indents or recesses.

The top is removably attached to or in use rests on the base in which the spindle means is positioned.

A lid means is hingeably attached to the top of the housing and movable from a closed to an open position to enable access to the slideable cutting means. In the closed position, a leading edge of the sheet material is adapted to protrude between the lid means and the top of the housing.

The lid means includes a recess or edge for maintaining the sheet material in position on the cutting surface, the recess having a substantially flat surface is adapted to contact the sheet material when the lid means is in the closed position. The recess allows visual access to the sheet material. The lid means is in the open position or removed, access is provided to the slideable cutting means.

The first and second surfaces of the cutting surface are adapted to substantially increase the friction of the sheet material moving over the cutting surface. The cutting surface is made from a rubber or elastomeric material forming the surface and a stiff polymer forming the base. The surface and base of the cutting surface are co-moulded or co-extruded. Part of the surface has a gloss finish whereas the remainder of the surface has a matt finish.

The cutting surface is removable from the housing for cleaning or replacement. The angle of the second surface of the cutting surface is at substantially 35 degrees to the first surface. The leading edge of the cutting surface is configured to increase tension in the sheet material when a leading edge of the sheet material is pulled away from the roll of sheet material and over the cutting surface.

The slit is adapted to bisect the angle between second surface of the cutting surface and the first surface of the cutting surface. The slideable cutting means engages with means to guide it along the slit. The slideable cutting means is slidably mounted by an arm on a rod or guide provided in the base or top of the housing.

The slideable cutting means is moveable up and down above the cutting surface to enable the slideable cutting means to be moved up and over an edge of the sheet material into a desired position to commence cutting. The movement of the slideable cutting means is restricted to prevent user injury from the cutting edge.

The slideable cutting means includes a cutting face having a first face and a second face, the first face is configured to correspond to the first cutting surface and the second face to the second cutting surface. The first cutting surface and the first cutting face are at one angle and the second cutting surface and the second cutting face are at an angle 35 degrees different. The surfaces of the slideable cutting means are parallel to but offset from the adjacent faces of the cutting surfaces. The surfaces of the slideable cutting means are of convex shape. In some embodiments at least one edge of the slideable cutting means have a chamfer and a radius.

The slideable cutting means is adapted to hold the sheet material in tension when it is gripped between the slideable cutting means and the cutting surface, so as to promote a clean cut in the sheet material.

The slideable cutting means is made of a slippery material such that the surface of the slideable cutting surface has a lower coefficient of friction compared to the sheet material. The cutting edge is removably installed in the slideable cutting means. The cutting edge is configured to be received in the slit without contacting the cutting surface. The cutting edge includes a metal blade. The blade has a sharpened portion which is a substantially isosceles triangularly shaped and bi-directional. The blade is provided with a cover for protecting the blade when it is not installed in the slideable cutting means.

The guide means is adapted to grip and guide the sheet material leaving the roll of is sheet material over the cutting surface and to hold the sheet material to prevent movement away from the cutting surface.

The guide means includes two substantially rectangular projections, positioned apart from one another, projecting towards the leading edge of the sheet of material. The assembly includes attachment means for removably mounting on a wall or a flat surface.

In one method of cutting sheet material there are provided the steps of: i) drawing a lead edge of the sheet material from a roll over a first cutting surface and a second cutting surface having a slit therebetween, one of the first and second surfaces being at a different angle relative to the other; and ii) sliding a cutting means along the slit through the sheet material so as to divide a piece of the sheet material from the roll.

The method includes threading a roll of sheet material onto a spindle means and mounting the spindle and roll in seating means within a housing.

It will be apparent to a person skilled in the art that changes may be made to the embodiment disclosed herein without departing from the spirit and scope of the invention in its various aspects.

It is to be recognised that various alterations and equivalent forms may be provided without departing from the spirit and scope of the present invention. This includes modifications within the scope of the appended claims along with all modifications, alternative constructions and equivalents. There is no intention to limit the present invention to the specific embodiments shown in the drawings. The present invention is to be construed beneficially to the applicant and the invention given its full scope.

In the present specification, the presence of particular features does not preclude the existence of further features. The words ‘comprising’, ‘including’ and ‘having’ are to be construed in an inclusive rather than an exclusive sense.

1. A cutting assembly for use in a kitchen, the cutting assembly including: a housing adapted to house a roll of sheet material such as plastic wrap, a cutting surface having a slit; and a slideable cutting arm having a cutting edge adapted for receipt in the slit when moved along the slit to cut the sheet material; wherein the cutting surface includes a high friction gripping surface having a gloss finish for gripping the sheet material on the cutting surface.

2. A cutting assembly as claimed in claim 1, wherein the surface is provided by a thermoplastic polyester elastomer.

3. A cutting assembly as claimed in claim 1, wherein the surface is provided by an elastomer coating over a rigid polymer substrate.

4. A cutting assembly as claimed in claim 1, wherein the cutting arm is hinged to allow slight up and down movement.

5. A cutting assembly as claimed in claim 1, wherein the cutting arm is moveable up and down above the cutting surface to enable the cutting arm to be moved up and over an edge of the sheet material into a desired position to commence cutting.

6. A cutting assembly as claimed in claim 1, wherein the cutting edge is provided by a cutting tool that is removably installed on the cutting arm.

7. A cutting assembly as claimed in claim 1, further comprising guide means for constraining the cutting arm to run parallel to the slit, the guide means being located behind the cutting arm, with an aperture being located between the guide means and the cutting surface, the sheet material being adapted to be fed through the aperture onto the cutting surface to overlie the slit.

8. A cutting assembly as claimed in claim 7, wherein the guide means comprises a rod and the cutting arm is mounted on the rod.

9. A cutting assembly as claimed in claim 1, wherein the housing is adapted to receive rolls of different dimensions.

10. A cutting assembly as claimed in claim 1, wherein the cutting surface includes a second portion so as to provide corresponding first and second surfaces having the slit therebetween, one of the surfaces being at an angle compared to the other.

11. A cutting assembly as claimed in claim 10, wherein the slit is adapted to bisect the angle between second surface of the cutting surface and the first surface of the cutting surface.

12. The cutting assembly of claim 11, wherein the angle of the second surface of the cutting surface is at substantially 35 degrees to the first surface.

13. The cutting assembly of claim 1, wherein the leading edge of the cutting surface is configured to increase tension in the sheet material when a leading edge of the sheet material is pulled away from the roll of sheet material and over the cutting surface.

14. The cutting assembly of claim 1, wherein a base of the housing is configured to receive one or more spindle means, each spindle means having a slightly smaller diameter than a core of the roll of sheet material so as to enable receipt of the spindle means within the core.

15. The cutting assembly of claim 14, wherein spacer means are provided to hold ends of each spindle means in chosen positions in the housing.

16. The cutting assembly of claim 14, wherein the ends of the spindle means project beyond the roll of sheet material to seat in seating means in the housing.

17. The cutting assembly of claim 16, wherein the seating means is adapted to receive more than one roll of sheet material.

18. The cutting assembly of claim 1, wherein the cutting surface is removable from the housing for cleaning or replacement.

19. The cutting assembly of claim 1, wherein the cutting edge is configured to be received in the slit without contacting the cutting surface.

20. A kitchen method for cutting sheet material comprising cling wrap typically found in a kitchen, comprising:
i) drawing a lead edge of the sheet material from a roll over a cutting surface comprising a a high friction gripping surface having a gloss finish for gripping the sheet material on the cutting surface; and
ii) sliding a cutting means along the slit through the sheet material so as to divide a piece of the sheet material from the roll.
